(19) United States
(12) Patent Application Publication
(10) Pub. No.: US 2014/0349135 A1
(43) Pub. Date: Nov. 27, 2014

(54) METHOD FOR COATING A STEEL SHEET WITH A METAL LAYER

(71) Applicant: THYSSENKRUPP RASSELSTEIN GmbH, Andernach (DE)

(72) Inventors: Helmut OBERHOFFER, St. Johann (DE); Benjamin LIEBSCHER, Welschneudorf (DE); Anika SZESNI, Kettig (DE); Reiner SAUER, Heimbach-Weis (DE); Karl-Ernst FRIEDRICH, Moers (DE)

(73) Assignee: THYSSENKRUPP RASSELSTEIN GmbH, Andernach (DE)

(21) Appl. No.: 14/287,321

(22) Filed: May 27, 2014

(30) Foreign Application Priority Data
May 27, 2013 (DE) 102013105392.0

(51) Int. Cl. C25D 5/48; B32B 15/01

(52) U.S. Cl. CPC C25D 5/48; B32B 15/012
USPC 428/684; 205/152; 204/206

(57) ABSTRACT

A method for coating a steel sheet with a metal layer includes the following steps: application of a first thin metal layer as a flash coating; melting the metal layer from the flash coating; and application of at least one additional metal layer onto the metal layer from the flash coating. To increase the corrosion resistance of the coated steel sheet and to improve the energy and resource efficiency of the coating method, with which a steel sheet having a high corrosion resistance and good weldability and with a good deep drawing and ironing behavior is to be produced, the thickness of the metal layer from the flash coating is at most 200 mg/m² and the metal layer from the flash coating is melted with electromagnetic radiation of high energy density.

### CROSS REFERENCE TO RELATED APPLICATIONS

This application claims priority under 35 U.S.C. §119 to German Patent Application No. 10 2013 105 392.0 filed 27 May 2013, the entire contents of which are incorporated herein by reference.

### FIELD OF THE DISCLOSURE

The disclosure pertains to a method for coating a steel sheet with a metal layer, to a device for performing the method, and to a steel sheet provided with such a coating.

### BACKGROUND

In methods known from prior art for galvanic coating of steel strips with a metal layer, the steel strip moving at a strip speed is passed through a number of successively arranged electrolyte baths in which a metal layer protecting the steel strip from corrosion is deposited. In a known method for producing tinplate for example, a steel strip is passed for electrolytic tin-plating through a number of successively arranged tin-plating tanks, in each of which a tin anode is arranged, in order to effectively coat the steel strip, connected as a cathode, with a tin layer. The steel strip typically passes through five to ten such tin-plating tanks, wherein a tin coating of approximately 0.1 to 0.7 g/m² is deposited in each tin-plating tank. This makes it possible to adjust a current density of less than 25 A/dm² in the individual tin-plating baths with a highest possible strip speed of up to 700 m/min. At higher current densities, there is the risk of an excessive development of heat, which can lead to a deterioration of the metallization quality if the heat arising in the confining tank cannot be dissipated.

After depositing the tin layer with a thickness, typically between 0.5 and 12 g/m², which is necessary for achieving a sufficient corrosion resistance, the galvanically deposited tin layer is melted by heating the coated steel strip in order to achieve a thin alloy layer at the transition between the steel strip surface and the tin layer and to produce a shiny tin surface. The tin layer is typically melted conductively in an annealing furnace or inductively by means of electromagnetic induction in an induction furnace. Melting a tin coating on a steel strip by irradiation with electromagnetic radiation having a high power density in order to form a thin alloy layer at the interface between the tin coating and the steel strip is known from DE 10 2011 000 984 A1.

A method for galvanic tin-plating of a steel strip in an acidic galvanization bath is also known from DE 1 496 835-A, in which a thin flash coating consisting of tin is first applied to the steel sheet and this flash coating layer made of tin is then liquefied by heating the steel sheet. After the liquefaction of the flash coating layer, a further tin-plating is performed in an additional acidic galvanization bath for applying an additional tin layer to the flash coating layer. The additional tin layer is again liquefied by heating the steel sheet. The weight of the flash coating layer (tin layer from the flash coating) is at least 22.7 g per standard area (“base box”), which corresponds to a coating application of the flash coating layer of at least 1.14 g/m². The steel sheet is brought to a temperature between 288° C. and 454° C. to liquefy the flash coating layer.

Another method for tin-plating a steel sheet is known from U.S. Pat. No. 3,062,726, in which a thin tin layer is first deposited on the steel sheet and then the tin is melted by heating the steel sheet to temperatures above the melting temperature of tin. Thereafter the steel sheet coated with the thin tin layer is quenched and treated with a pickling agent and then a second tin layer is applied to the first thin tin layer. The thickness of the first thin tin layer preferably corresponds to a coating of 18-27 grams per standard area (“base box”), corresponding to a coating of 0.9 to 1.35 g/m².

The multistage coating method known from the prior art, in which a thin first metal coating (flash coating) is applied to a steel sheet in a first stage, the thin metal coating is then melted and thereafter at least one additional, thicker metal coating is applied to the first metal coating, is characterized by a good corrosion resistance of the coated steel sheet. However, the production method is expensive and energy-intensive due to the method step of melting the first metal layer, because the entire steel sheet must be brought to temperatures above the melting temperature of the coating material in the metal layer in order to melt the first thin metal layer. Moreover, a comparatively large overall thickness of the applied metal layer is necessary in order to achieve a good corrosion resistance of the coated steel sheet.

### SUMMARY

Proceeding from this point, an embodiment of the disclosure addresses the problem of improving the corrosion resistance of a steel sheet coated with metal, as well as the energy and resource efficiency of the coating method. There is also the problem of providing a steel sheet coated with a metal layer of high corrosion resistance, which simultaneously has good weldability and good deep drawing and ironing behavior and is suitable for producing packaging containers, particularly cans.

This problem is solved by at least one embodiment of the method of the disclosure and by at least one embodiment of the device of the disclosure as well as by at least one embodiment of the steel sheet of the disclosure. Preferred embodiments of the method according to the disclosure are also set forth herein.

In an embodiment of the method according to the disclosure, a first thin metal layer is initially deposited as a flash coating on the steel sheet, preferably by means of galvanic deposition of a thin metal layer in an electrolysis bath. The thin metal layer from the flash coating is then melted by heating the steel sheet with the flash coating to temperatures above the melting temperature of the metal layer. Thereafter at least one additional metal layer of the same material as the metal layer in the flash coating is deposited onto the flash coating. This is preferably likewise done by means of galvanic deposition of the additional metal layer on the metal layer from the flash coating. According to the disclosure, the thickness of the metal layer for the flash coating is at most 200 mg/m² and is therefore considerably thinner than the thicknesses of the flash coating layers that were known from the publications of the prior art mentioned above. The additional metal layer, which is applied in the method according to the disclosure onto the melted metal layer from the flash coating, is ordinarily thicker than the thin metal layer from the flash coating, e.g. by a factor of approximately 2 to 120 and preferably by a factor of 4 to 60.

This thin metal layer from the flash coating is melted—differently from the method known from prior art—by irradiation of the thin metal layer with radiation having a high energy density, namely electromagnetic radiation, particularly laser radiation, or with an electron beam. The metal layer is expediently irradiated by introducing a directed beam onto the surface of the metal layer, wherein the beam can either be electromagnetic radiation and particularly laser radiation, or an electron beam. For melting the thin metal layer from the flash coating, a radiation source such as a laser or an electron gun is used, with which a sufficiently high energy can be irradiated into the thin metal layer from the flash coating that the flash coating is completely melted over its entire thickness of at most 200 mg/m² up to the interface with the steel sheet. Thereby the thin metal layer from the flash coating is converted at least substantially completely into an alloy layer that consists of iron atoms from the steel sheet and atoms of the metal of the metallic layer.

Due to the complete melting of the thin metal layer from the flash coating, an alloy layer consisting of atoms of the metal in the metal layer and of iron atoms from the steel sheet is formed at the interface between the thin metal layer from the flash coating and the steel sheet. The thin metal layer from the flash coating is converted at least largely completely into a thin alloy layer by the complete melting by means of irradiation of the magnetic radiation, i.e. after the thin metal layer from the flash coating has melted, it consists at least substantially of an alloy of atoms from the metal in the metal layer and iron atoms from the steel sheet.

The energy density introduced with the radiation into the thin metal layer from the flash coating and the irradiation time are expediently selected such that just the thin metal layer from the flash coating is melted completely over its entire thickness up to the interface with the steel sheet, without a significant introduction of energy by the radiation into the underlying steel sheet. The input of energy density is thus limited substantially locally to the thickness of the thin metal layer in the flash coating. Thereby considerable energy can be saved, because the steel sheet is not heated by the locally limited energy input into the region near the surface. The irradiation time is dependent on the strip speed of the steel strip, with which the latter is passed through the coating tanks in which the steel strip is coated with the metal layer. For strip speeds in the range of several hundred meters per minute, short irradiation times in the range of μs result. It is also possible to use pulsed radiation sources such as pulsed lasers, in which case the pulse duration is preferably below 10 μs, to set an expedient irradiation time.

Due to the considerably thinner metal layer from the flash coating, the method according to the disclosure is distinguished in relation to the prior art in that a considerable amount of coating material can be saved. It has been found surprisingly that despite the very small layer thickness, at most 200 mg/m², of the metal layer for the flash coating, a very thin and very dense alloy layer at the interface between the thin metal layer from the flash coating and the steel sheet is formed by the locally limited melting of the thin metal layer from the flash coating. This very thin and simultaneously dense alloy layer leads, despite its very low thickness, to a considerable increase in the corrosion resistance of the steel sheet coated according to the disclosure. The very thin alloy layer with an alloy layer application of at most 200 mg/m² guarantees outstanding corrosion protection, particularly because of its very high density. It can be assumed that this very high corrosion protection can be achieved with even smaller alloy layer applications of only 20-100 mg/m² for example. It is technologically difficult, however, to adjust the layer thickness of the flash coating to below approximately 50 mg/m² because in case of a galvanic deposition of the metal layer from the flash coating in the coating baths, a minimum current density must be set in order to keep the galvanic coating process stable.

In order to melt the thin metal layer from the flash coating, an energy density of 0.03-3 J/cm², preferably 0.1-2 J/cm², for the radiation with which the temperature of the thin metal layer is raised to values above the melting temperature has proved suitable.

If a high surface sheen of the steel sheet coated according to the disclosure is to be produced, it is possible in an expedient embodiment of the method according to the disclosure for the entire metal surface to be additionally melted by heating to a temperature above the melting temperature of the material subsequent to the deposition of the additional metal layer onto the thin metal layer from the flash coating. This melting of the entire metal coating preferably takes place inductively in an induction furnace and leads to a shiny surface as is desired, for example, for use of metal coated steel plates as packaging steel. The surface of the (additional or last) metal coating can also be melted with high-energy radiation however, that is by irradiation with electromagnetic radiation or an electron beam as in the melting of the flash coating.

With the method according to the disclosure, a steel sheet provided with a metal coating can be produced, in which a thin alloy layer consisting of steel atoms from the steel sheet and metal atoms from the coating material is formed in the interface between the surface of the steel sheet and the metal coating, wherein the thickness of the alloy layer is at most 200 mg/m² and the content of free, unalloyed metal in the metal coating is at least 50% and preferably lies between 80 and 99%. The thin alloy layer arises due to the melting of the thin metal layer from the flash coating. Because of the subsequent deposition of an additional (thicker) metal layer onto the thin metal layer from the flash coating, a relatively high metallic (i.e. non-alloyed) content in the coating is present. Particularly if a final heating of the additional (thicker) metal layer is completely forgone or if it takes place only for a brief time at a temperature that is slightly above the melting temperature of the coating material, the entire quantity of the additional metal coating can be present in non-alloyed form (i.e. as free tin for example in the case of tin-plating). This is advantageous for example for the weldability of the coated steel sheet and is responsible for a good deep drawing and ironing behavior due to the good lubricant effect of the metallic (non-alloyed) content of the coating.

### BRIEF DESCRIPTION OF THE DRAWING

These and further advantages of the disclosure follow from the embodiments of the disclosure described below with reference to the accompanying drawing. The drawing shows:

FIG. 1 is a schematic representation of a coating device for a steel strip with a plurality of coating baths arranged in succession in the direction of strip travel.

### DETAILED DESCRIPTION

The below-described embodiment of the method according to the disclosure pertains to tin-plating of a steel strip for producing tinplate, which can be used, for example, for producing packaging containers, particularly cans for foodstuffs. The disclosure is not limited to the tin-plating of steel strips, however, and can be used in a corresponding manner for coating steel strips with other metal layers, e.g. tin or nickel. The substrate (steel sheet) in the described embodiment is a steel strip, which is passed through a plurality of tin-plating tanks arranged in succession in the direction of strip travel. The disclosure is not limited to coating a steel strip in such a strip coating system, however, but can also be used in other coating systems in which, for example, steel sheets in panel form are provided successively with a metal coating in coating tanks

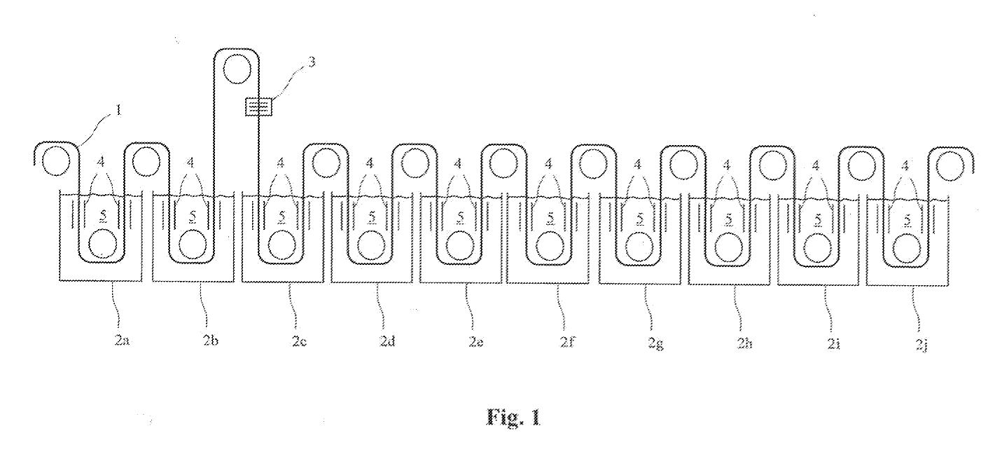

To produce a tin plated steel sheet (tinplate), a steel sheet 1 in the form of a steel strip is passed with a strip speed in the range of 100-700 m/min through a plurality of coating baths 2a, 2b, 2c, . . . arranged in succession in the direction of strip travel, as shown schematically in FIG. 1. In the embodiment, the coating baths 2 are constructed as tin-plating baths, in each of which a tin anode 4 is arranged and which are filled with an electrolyte 5 (e.g. methanesulfonic acid). The steel sheet 1 moved through the tin-plating tank is connected as a cathode, in order for a thin tin layer to be deposited on both sides of the steel strip. In the coating device shown schematically in FIG. 1, a total of ten successively arranged tin-plating tanks (2a, 2b, . . . 2j) are provided. However, more or fewer tin-plating tanks can be used depending on the desired total thickness of the metal layer to be applied to the steel strip. A thin tin layer is deposited galvanically on the surfaces of the steel strip in each of the tin-plating tanks, the layer thickness deposited per tin-plating tank expediently lying in the range of 50-500 mg/m². The current density set in the galvanic tin-plating tanks is preferably between 10 and 25 A/dm² and the bath temperatures of the electrolyte are generally between 30° C. and 50° C.

In the front coating baths (tin-plating tanks) 2a, 2b, a thin flash coating of tin is first deposited electrolytically (on both sides the steel strip 1). The layer thickness of this tin flash coating is expediently between 50 and at most 200 mg/m². The layer thickness of the thin flash coating is preferably between 80 and 150 mg/m² and especially preferably approximately 120 mg/m². After passing through the first coating baths 2a, 2b, the thin tin layer deposited of the flash coating deposited there is melted on one side of the steel sheet. For this purpose, electromagnetic radiation, which is generated by a laser 3 for example, is irradiated on one side of the steel sheet 1 onto the surface of the thin tin layer. A radiation source 3 such as a laser or an electron gun is arranged for this purpose between the second coating bath 2b and the third coating bath 2c. The energy density and the irradiation time of the beam emitted by the radiation source 3 are selected such that the thin layer of tin from the flash coating that was applied in the front tin-plating tanks is completely melted over its entire thickness up to the interface with the steel strip. Energy densities of the radiation between 0.03 and 3.0 J/cm² and preferably between 0.1 and 2.0 J/cm² have proved suitable for this purpose. The thin layer of tin from the flash coating is heated only briefly to temperatures between the melting point of tin (250° C.) and 500° C., and preferably to temperatures in the range of approximately 300° C. to 400° C. After the thin layer of tin from the flash coating has melted, it is cooled down to temperatures below the melting temperature of tin. The cooling is done expediently and in an energy-saving manner by self-cooling with heat conduction through the still cold steel strip 1.

After the melting of the thin layer of tin from the flash coating and cooling, the steel strip 1 is passed sequentially through the subsequent rear tin-plating tanks 2c, 2d, . . . 2j. There additional layers of tin are galvanically deposited on both sides of the steel strip. Additional tin layers are also deposited on the melted thin layer of tin from the flash coating that was applied in the front tin-plating tanks 2a, 2b, until a tin layer with the desired thickness is present on both sides of the steel strip 1. The layer thickness of the entire tin layer, which consists of the thin layer tin from the flash coating and the additional tin layers from the rear tin-plating tanks 2c . . . 2j, is preferably between 0.5 g/m² and 12 g/m².

After the deposition of the additional tin layer, the steel sheet can again be bought briefly to temperatures above the melting temperature of the tin, in order to melt at least the area at the surface of the tin layer. A surface sheen of the tin coating is achieved by this melting of the surface area of the tin layer and a subsequent quenching in a water bath. Differently from the methods known in the prior art, the tin layer need no longer be melted over its entire thickness in order to obtain both a surface sheen and a thin alloy layer at the interface between the tin coating and the steel sheet. For achieving the surface sheen, it is instead sufficient only to melt the area of the tin coating close to the surface, because the thin alloy layer that ensures a high corrosion resistance of the tinplate has already been produced by the melting of the thin layer of tin from the flash coating that was applied in the front tin-plating tanks 2a, 2b. To produce the surface sheen at the surface of the tin coating, it is sufficient to heat the coated steel sheet merely to temperatures in the range of 232° C. (melting temperature of the tin) to approximately 300° C., and preferably to temperatures between 240° C. and 260° C. In this way considerable energy can be saved compared to the melting methods known from the prior art because, in the known melting methods, the tin coating has to be heated to substantially higher temperatures both for producing the surface sheen and for forming the thin alloy layer at the interface to the steel sheet.

The tinplate produced in this manner is distinguished by a very high corrosion resistance, which is created by the thin and very dense alloy layer at the interface between the thin layer of tin from the flash coating and the steel strip. ATC values of less than 0.1 and even less than 0.05 μA/cm² can be measured, which indicates a very good corrosion resistance.

The tinplate produced in the described example of the method according to the disclosure is particularly suitable for producing packaging containers, especially cans for foods. The side of the steel sheet on which the thin layer of tin from the flash coating has been melted is expediently used for the inner side of the can, because this side of the steel sheet has a high corrosion resistance due to the formation of the alloy layer at the interface between the tin coating of tin and steel sheet. The galvanically deposited tin on the other side of the steel sheet expediently remains as free tin. This leads to a good stretching behavior of the tin plated steel sheet during deep drawing and ironing, because the free tin acts as a lubricant in that case.

The disclosure is not limited to the described embodiment. Thus the thin layer of tin from the flash coating need not be applied in the first two tin-plating tanks 2a, 2b, but can also be deposited only in the first tin-plating tank 2a or in the first three tin-plating tanks 2a-2c. The radiation source 3 for melting the tin layer from the flash coating is then arranged between the first tin-plating tank 2a and the second tin-plating tank 2b or between the third tin plating 2c tank and the fourth tin-plating tank 2d, etc. The thickness of the tin layer deposited in the front tin-plating tanks is adjusted by suitable selection of the current density in such a manner that the total thickness of the thin layer of tin from the flash coating does not exceed the upper limit according to the disclosure of 200 mg/m². It is also possible to melt the thin layer of tin from the flash coating not only on one side of the steel strip but also on both sides, before deposition of the additional tin layers in the rear tin-plating tanks It is possible to forgo the additional melting of the (thick) tin layer deposited in the rear tin-plating tanks if a surface sheen of the tin coating is not necessary (e.g. for producing cans with the deep drawing and ironing method (DWI)).

If an electron beam is used for melting the thin metal layer from the flash coating, it is expedient to perform at least the step of the method in which the melting of the flash coating takes place in a vacuum (expediently at least 10⁻² mbar). This can avoid energy losses during irradiation with the electron beam.

The steel sheet produced according to the disclosure is distinguished by a very good corrosion stability, which is produced by the corrosion-resistant alloy layer between the steel sheet surface and the metal coating. The thin alloy layer arises due to the melting of the thin metal layer from the flash coating. By means of the process control according to the disclosure, the thickness of the alloy layer can be adjusted by a suitable selection of the thickness of the flash coating layer. Due to the subsequent deposition of a thick metal layer onto the thin metal layer from the flash coating in the rear coating baths, a relatively high metallic (i.e. non-alloyed) content in the coating is present (with a specified layer deposition of the metal coating). This is advantageous for example for the weldability of the coated steel sheet (e.g. for producing three-part cans) and is responsible for a good deep drawing and ironing behavior due to the good lubricant effect of the metallic (non-alloyed) content of the coating. The metallic (non-alloyed) content in the coating is expediently at least 50% and preferably at least 70% and is particularly preferably between 80% and 99%.

It has been surprisingly shown that the very thin metal coating of the flash coating after melting by means of irradiation with a directed beam of electromagnetic radiation or an electron beam has a good surface structure and arrangement, which allows for the deposition of a metal coating onto the melted and alloyed metal coating from the flash coating. In the area close to the surface of the metal coating from the flash coating, the melting produces rod-shaped growth nuclei on which the metal atoms of the coating material in the subsequent coating can grow, and thus guarantees a good adhesion of the further metal coating to the (alloy) metal coating from the flash coating.

All references cited herein are expressly incorporated by reference in their entirety. In addition, unless mention was made above to the contrary, it should be noted that all of the accompanying drawings are not to scale. There are many different features to the present disclosure and it is contemplated that these features may be used together or separately. Thus, the disclosure should not be limited to any particular combination of features or to a particular application of the disclosure. Further, it should be understood that variations and modifications within the spirit and scope of the disclosure might occur to those skilled in the art to which the disclosure pertains. Accordingly, all expedient modifications readily attainable by one versed in the art from the disclosure set forth herein that are within the scope and spirit of the present disclosure are to be included as further embodiments of the present disclosure.

1. Method for coating a steel sheet with a metal layer, comprising the following steps:
application of a first thin metal layer as a flash coating, wherein the thickness of the metal layer from the flash coating is at most 200 mg/m²,
melting the metal layer from the flash coating by irradiating the metal layer with electromagnetic radiation or an electron beam, wherein the metal layer from the flash coating is completely melted over its entire thickness and is thereby converted substantially completely into an alloy layer of iron atoms from the steel sheet and atoms of the metal in the metal coating, and
application of at least one additional metal layer onto the alloy layer produced by the melting.

2. Method according to claim 1, wherein the melted metal layer from the flash coating is cooled after melting to a temperature below the melting temperature of the metal layer.

3. Method according to claim 1, wherein the energy density introduced into the metal layer from the flash coating by the electromagnetic radiation or the electron beam and the irradiation time are selected such that the metal layer from the flash coating melts completely over its entire thickness down to the interface to the steel sheet.

4. Method according to claim 3, wherein the irradiation time is at most 10 μs and preferably between 10 μs and 1 μs.

5. Method according to claim 1, wherein the thickness of the metal layer from the flash coating lies between 50 mg/m² and 200 g/m² and is preferably 100 mg/m².

6. Method according to claim 1, wherein the energy density of the electromagnetic radiation that is irradiated for the flash coating is between 0.03 J/cm² and 3 J/cm² and preferably between 0.1 and 2 J/cm².

7. Method according to claim 1, wherein after the application of the additional metal layer onto the metal layer from the flash coating, the coated steel plate is heated inductively to a temperature above the melting temperature of the metal layer in order to melt the entire metal coating.

8. Method according to claim 7, wherein after the application of the additional metal layer onto the metal layer from the flash coating, the coated steel sheet is heated to a temperature between 232° C. and 300° C. and preferably between 240° C. and 260° C.

9. Method according to claim 1, wherein the metal layer from the flash coating is applied on both sides by means of galvanic deposition of the metal layer onto the steel sheet, and in that the metal layer from the flash coating is melted on only one side.

10. Method according to claim 1, wherein the metal from the flash coating is melted by irradiating a directed beam onto the surface of the metal layer from the flash coating, wherein the beam is continuous or pulsed, preferably with a maximum pulse duration of 1 μs.

11. Method according to claim 1, wherein the coating material of the metal layer is tin, zinc or nickel, wherein the metal layer for the flash coating and the additional metal layer are made from the same material.

12. Method according to claim 1, wherein the coating application of the additional metal layer(s) is between 0.5 g/m² and 12 g/m².

13. Method according to claim 1, wherein the metal layer from the flash coating and the additional metal layer are each a tin layer and in that the tin layer from the flash coating is heated for melting to a temperature between 250° C. and 500° C., and preferably between 300° C. and 400° C., before the melted tin layer from the flash coating is coated with at least one additional tin layer.

14. Device for galvanic coating of a steel strip with a metal layer, with a plurality of successively arranged coating baths, through which the steel strip is passed in a strip running direction to apply the metal layer by galvanic deposition, wherein a thin metal layer is first applied as a flash coating in the furthest forward coating baths in the strip running direction, and then additional metal layers are applied in the downstream coating baths, wherein a radiation source for electromagnetic radiation or an electron beam is arranged downstream of the first coating bath or baths in the strip running direction, in order to melt the metal layer from the flash coating with electromagnetic radiation, particularly a laser beam, or an electron beam.

15. Steel sheet provided with a metal coating, wherein a thin alloy layer of steel atoms from the steel sheet and metal atoms from the coating material is formed in the interface between the surface of the steel sheet and the metal coating, wherein the thickness of the alloy layer is at most 200 mg/m² and the content of free, unalloyed metal in the metal coating is at least 50% and preferably lies between 80% and 99%.
